(19) United States
(12) Patent Application Publication
(10) Pub. No.: US 2021/0287159 A1
(43) Pub. Date: Sep. 16, 2021

(54) WORK ASSISTANCE SYSTEM, WORK ASSISTANCE METHOD, AND PROGRAM RECORDING MEDIUM

(71) Applicant: NEC Corporation, Minato-ku, Tokyo (JP)

(72) Inventors: Shinji NAKADAI, Tokyo (JP); Junya SAKAMOTO, Tokyo (JP)

(73) Assignee: NEC Corporation, Minato-ku, Tokyo (JP)

(21) Appl. No.: 16/336,526

(22) PCT Filed: Sep. 29, 2016
(86) PCT No.: PCT/JP2016/004389

§ 371 Date: Mar. 26, 2019

(51) Int. Cl. G06Q 10/08

(52) U.S. Cl. CPC G06Q 10/087

(57) ABSTRACT

Provided is for assisting work of an employee in a store efficiently. A work assistance system includes: an identification unit that identifies, based on each of a plurality of products to be arranged at a certain place, time information indicating a time associated with the product; and a change unit that changes arrangement of the plurality of products, based on rule information including at least a condition for arrangement according to a time indicated by the identified time information.

### TECHNICAL FIELD

The present disclosure relates to a work assistance system, a work assistance method, and a program recording medium.

### BACKGROUND ART

One of work in a store is shelf stocking work. The shelf stocking work is generally work of carrying products out of a warehouse to a store and displaying the products on a product shelf in the store. Such shelf stocking work causes a certain burden on an employee and an operation of the store. For example, some investigation results indicate that about 15% of work of an employee is spent in the shelf stocking work in convenience stores in Japan.

For example, there is a technique described in PTL 1 as a technique for assisting work of an employee in a store. PTL 1 discloses a system operable in such a way as to replenish a display shelf with an inventory item at an inventory replenishment station.

### CITATION LIST

### Patent Literature

[PTL 1] Japanese Unexamined Patent Application Publication (Translation of PCT Application) No. 2015-533749

### SUMMARY OF INVENTION

### Technical Problem

Some products have a time limit for sales thereof. For example, food and beverages generally have an expiration date and a best-before date. Particularly, for perishable food, such as vegetables, fruits, fresh fish, and meat, and precooked processed food (such as rice balls, packed lunches, and sandwiches), a product having an early expiration date needs to be on sale first, otherwise more products past an expiration date are generated. Thus, an employee is required to perform work of not only simply arranging products, but also checking an expiration date and rearranging products in an appropriate order, during the shelf stocking work. However, the technique disclosed in PTL 1 does not deal with such a time limit in any way during replenishment of products.

An illustrative object of the present disclosure is to provide a technique for efficiently assisting work of an employee in a store.

### Solution to Problem

In one aspect, a work assistance system is provided which includes: an identification means that identifies, based on each of a plurality of products to be arranged at a certain place, time information indicating a time associated with the product; and a change means that changes arrangement of the plurality of products, based on rule information including at least a condition for arrangement according to a time indicated by the identified time information.

In another aspect, a work assistance method is provided which includes:

identifying, based on each of a plurality of products arranged at a certain place, time information indicating a time associated with the product; and

changing arrangement of the plurality of products, based on rule information including at least a condition for arrangement according to a time indicated by the identified time information.

In another aspect, program recording medium is provided, that is computer-readable and records a program for causing a computer to execute:

processing of identifying, based on each of a plurality of products arranged at a certain place, time information indicating a time associated with the product; and

processing of changing arrangement of the plurality of products, based on rule information including at least a condition for arrangement according to a time indicated by the identified time information.

### Advantageous Effects of Invention

According to the present disclosure, work of an employee in a store is efficiently assisted.

### BRIEF DESCRIPTION OF DRAWINGS

FIG. 1 is a block diagram illustrating one example of a configuration of a work assistance system.

FIG. 2 is a flowchart illustrating one example of a work assistance method.

FIG. 3 is a block diagram illustrating another example of a configuration of a work assistance system.

FIG. 4 is a diagram illustrating a configuration example of a mobile robot.

FIG. 5A is a diagram illustrating a configuration example of a shelf robot.

FIG. 5B is a perspective diagram illustrating the configuration example of the shelf robot.

FIG. 6 is a sequence chart illustrating one example of an operation of the mobile robot and the shelf robot.

FIG. 7 is a flowchart illustrating one example of rearrangement processing.

FIG. 8A is a diagram illustrating a specific example (before processing) of the rearrangement processing.

FIG. 8B is a diagram illustrating a specific example (after processing) of the rearrangement processing.

FIG. 9 is a block diagram illustrating still another example of a configuration of a work assistance system.

FIG. 10 is a diagram illustrating a configuration example of a transportation robot.

FIG. 11 is a perspective diagram illustrating a configuration example of a rearrangement robot.

FIG. 12 is a flowchart illustrating one example of processing performed by a control device.

FIG. 13 is a block diagram illustrating one example of a hardware configuration of a computer device.

FIG. 14 is a block diagram illustrating still another example of a configuration of a work assistance system.

### DESCRIPTION OF EMBODIMENTS

### First Example Embodiment

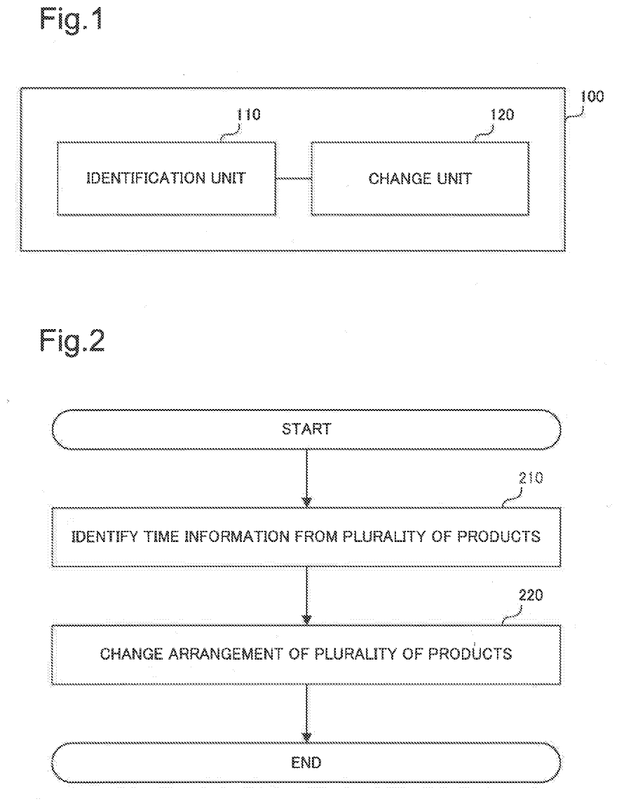

FIG. 1 is a block diagram illustrating a whole configuration of work assistance system 100 according to one example embodiment. Work assistance system 100 is a system for assisting work of an employee in a store. Work assistance system 100 includes at least identification unit 110 and change unit 120.

Work assistance system 100 is constituted of one or a plurality of devices. For example, work assistance system 100 may include a device including identification unit 110 and a different device including change unit 120. Alternatively, work assistance system 100 may include a device including identification unit 110 and change unit 120, and a different device including another component.

Identification unit 110 identifies information associated with a product based on the product. For example, identification unit 110 optically recognizes a character and a bar code on a surface of a product, and identifies information based on a recognition result thereof. Alternatively, identification unit 110 may identify information by recognizing a characteristic (such as shape and color) of an external appearance of a product. For example, identification unit 110 can also specify information associated with each product, by identifying an individual object (i.e., a product) by recognizing a difference of a so-called object fingerprint, i.e., a minute pattern of an object surface.

Note that identification unit 110 may identify information associated with a product without using an optical method. For example, identification unit 110 may be configured to electromagnetically read information recorded in a radio frequency (RF) tag. Further, identification unit 110 may identify information related with a product by combining a plurality of methods. A specific hardware configuration of identification unit 110 may be a known configuration according to a product on sale in a store, and is not limited to a specific configuration.

Identification unit 110 is configured to be able to identify information from each of a plurality of products. For example, identification unit 110 may be configured to be movable itself, and may recognize a character and a bar code from a plurality of products arranged at a certain place. Alternatively, identification unit 110 may recognize a character and a bar code from a product by moving the product instead of identification unit 110 itself.

Information identified by identification unit 110 includes time information. The time information is, for example, information indicating a time associated with a product. The time associated with the product herein is, for example, a date of manufacture, a time of manufacture, a best-before date, an expiration date. The time information of a product having information identified by identification unit 110 may vary with each product. For example, products displayed in a store have different expiration dates, and are mixed together.

Note that information identified by identification unit 110 may include information other than the time information. For example, information identified by identification unit 110 may include product information that identifies a product. The product information is, for example, a product name, a manufacturer's name, a manufacturing number. The product information herein may be information varying with each product (i.e., each one item), or information common to products of the same kind.

Change unit 120 changes arrangement of a product. The change in arrangement herein includes a change in arrangement of a product being already arranged and a change in arrangement by adding a new product to a product being already arranged. Change unit 120 moves a product by holding the product with a manipulator (a so-called robot arm), for example. Alternatively, change unit 120 may move a product by a belt or a roller. A specific hardware configuration of change unit 120 may be a known configuration according to a product on sale in a store, and is not limited to a specific configuration.

Change unit 120 changes arrangement of a product, based on information identified by identification unit 110. For example, change unit 120 changes arrangement of a product, based on rule information defined in advance. The rule information is information in which a rule for arrangement of a product is described. The rule information includes one or a plurality of conditions for arrangement of a product. The condition herein includes a condition associated with the information identified by identification unit 110. For example, the rule information may include a condition for arrangement associated with the time information or the product information.

In some aspects, change unit 120 changes arrangement of a plurality of products, based on times indicated by pieces of time information identified from the plurality of products by identification unit 110. For example, when time information indicates an expiration date, change unit 120 rearranges a plurality of products in such a way that the plurality of products are arranged in an ascending order (order of early expiration date) or in a descending order (order of late expiration date).

Note that change unit 120 may determine whether arrangement of a product having information identified by identification unit 110 needs to be changed. For example, change unit 120 may determine arrangement of a product before a change, based on information identified by identification unit 110. When the arrangement of a product determined in such a manner is the same as original arrangement, change unit 120 may not change the arrangement of the product.

FIG. 2 is a flowchart illustrating a work assistance method by work assistance system 100. In Step 210, identification unit 110 identifies time information indicating a time associated with each of a plurality of products arranged at a certain place, based on each of the products. In Step 220, change unit 120 changes arrangement of the plurality of products, based on the time information identified in Step 210 and rule information. Specifically, change unit 120 changes arrangement of a product having the time information identified according to a condition described in the rule information.

As described above, work assistance system 100 in the present example embodiment has a configuration in such a way as to identify pieces of time information from a plurality of products, and change arrangement of the plurality of products, based on the time information and rule information. This configuration allows the arrangement of the plurality of products to be changed (i.e., rearranged) according to a condition included in the rule information.

Therefore, work assistance system 100 can efficiently assist work of an employee in a store. For example, work assistance system 100 can further increase an opportunity to sell a product having an earlier expiration date first, by arranging a plurality of products having an earlier expiration date in positions (for example, on a near side to a customer) where a customer more easily picks up the products, in comparison with when a plurality of products are not arranged in such a manner. In this way, an employee in a store can reduce a burden of work, such as work of rearranging products in order of expiration date on one's own, and work of finding and disposing of a product past an expiration date.

### Second Example Embodiment

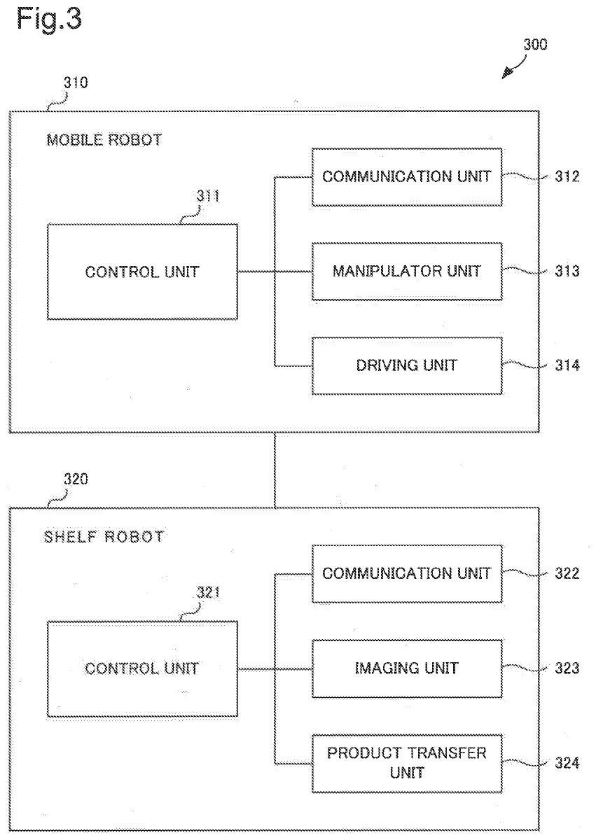

FIG. 3 is a block diagram illustrating a configuration of work assistance system 300 according to another example embodiment. Work assistance system 300 includes mobile robot 310 and shelf robot 320. Work assistance system 300 is installed in a store such as a convenience store. Work assistance system 300 corresponds to one example of work assistance system 100 in the first example embodiment. Note that description of matters common to the first example embodiment will be appropriately omitted in the present example embodiment.

Mobile robot 310 and shelf robot 320 are devices configured to be communicable to each other. For example, mobile robot 310 and shelf robot 320 wirelessly transmit and receive data by a predetermined communication method such as a wireless local area network (LAN). Note that mobile robot 310 and shelf robot 320 may transmit and receive data via another device (such as a server device). Further, shelf robot 320 is installed in a specific position in a store. On the other hand, mobile robot 310 can move from a certain place to a different place. Note that a plurality of mobile robots 310 and shelf robots 320 may be located inside a store.

Mobile robot 310 includes control unit 311, communication unit 312, manipulator unit 313, and driving unit 314. Manipulator unit 313 corresponds to one example of change unit 120 in the first example embodiment. More specifically, manipulator unit 313 can achieve a function corresponding to change unit 120 in the first example embodiment, by cooperating with control unit 311.

Control unit 311 controls an operation of each unit in mobile robot 310. Control unit 311 includes an arithmetic processing device, such as a central processing unit (CPU), and a memory. Control unit 311 can control an operation of each unit in mobile robot 310 by executing a program. For example, control unit 311 can control movement of a product by manipulator unit 313.

Rule information and size information about each product are stored in the memory of control unit 311. The rule information and the size information are stored in association with product information. The rule information is information in which a rule of arrangement of a product is described. The size information is information in which a size, i.e., dimensions including a width, a height, and a depth, of a product is described. It is assumed in the present example embodiment that products having common product ID have the same size (i.e., a fixed form). Note that the size information may further include other information (such as a weight of a product).

Communication unit 312 exchanges data with shelf robot 320. For example, communication unit 312 includes a wireless communication chip and an antenna related to a predetermined communication method. Communication unit 312 can receive time limit information described later and the product information from shelf robot 320. The time limit information corresponds to one example of the time information.

Manipulator unit 313 moves a product. Manipulator unit 313 can change arrangement of a plurality of products by holding and moving a product. For example, manipulator unit 313 has a function of holding a product, and a function of moving a product in a vertical direction and a horizontal direction.

Driving unit 314 moves mobile robot 310. Driving unit 314 includes a tire (or a crawler) and a motor that drives the tire (or the crawler). Alternatively, driving unit 314 may include a Mecanum wheel or an Omni wheel movable in multi-direction. Note that driving unit 314 may be operated by manipulation of a user (an operator).

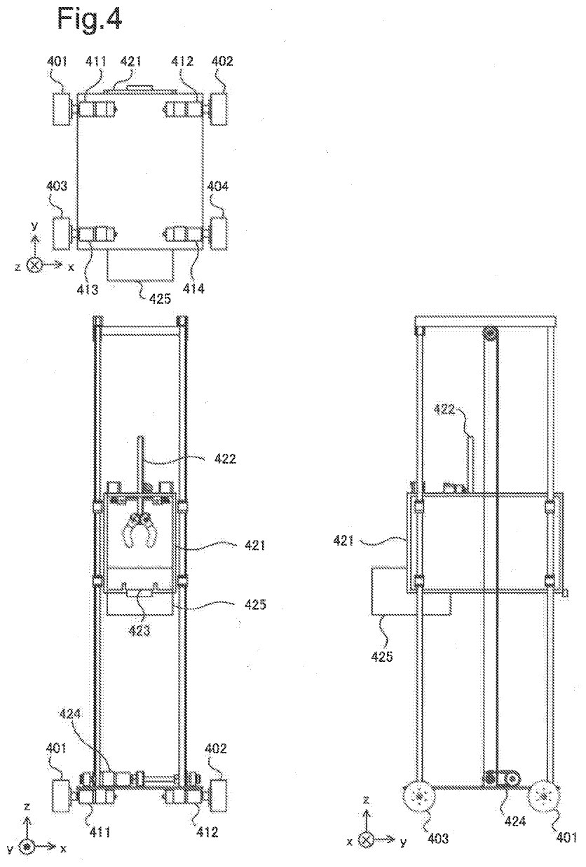

FIG. 4 is a diagram (front view, side view, and bottom view) illustrating a configuration example of mobile robot 310. Mobile robot 310 includes Mecanum wheels 401, 402, 403, and 404, motors 411, 412, 413, and 414, casing 421, manipulator 422, conveyor 423, lift 424, and box 425.

Mecanum wheels 401 to 404 and motors 411 to 414 correspond to one example of driving unit 314. Mecanum wheels 401 to 404 and motors 411 to 414 move mobile robot 310 by being driven according to control by control unit 311.

Casing 421, manipulator 422, conveyor 423, lift 424, and box 425 correspond to one example of manipulator 313. Casing 421 places a product, and also moves manipulator 422 supported by an upper surface thereof in x, y, and z-axis directions (i.e., three directions) in the diagram. Manipulator 422 holds a product with an end-effector. While a specific configuration of manipulator 422 is not particularly limited, manipulator 422 may be configured to absorb and hold a product by, for example, a vacuum pad provided on the end-effector. Conveyor 423 moves a product in the y-axis direction in the diagram. Conveyor 423 is, for example, a belt conveyor. Conveyor 423 can transfer a product from mobile robot 310 to shelf robot 320, by moving the product in a negative y-axis direction in the diagram. Further, when conveyor 423 transfers a product from shelf robot 320 to mobile robot 310, conveyor 423 moves the product in a positive y-axis direction in the diagram. Lift 424 moves casing 421 in the z-axis direction (i.e., an up-and-down direction) by a motor, a belt, and a pulley. Box 425 houses some of products (for example, a product past an expiration date) housed in casing 421.

Shelf robot 320 includes control unit 321, communication unit 322, imaging unit 323, and product transfer unit 324. Control unit 321 corresponds to one example of identification unit 110 in the first example embodiment. More specifically, control unit 321 can achieve a function corresponding to identification unit 110 in the first example embodiment, by cooperating with imaging unit 323.

Control unit 321 includes an arithmetic processing device, such as a CPU, and a memory. Control unit 321 can control an operation of each unit in shelf robot 320 by executing a program. For example, control unit 321 can identify time limit information and product information, based on image data supplied from imaging unit 323, and transmit the time limit information and the product information to mobile robot 310 via communication unit 322. In this case, control unit 321 controls imaging of a product by imaging unit 323 and data communication by communication unit 322.

Communication unit 322 exchanges data with mobile robot 310. For example, communication unit 322 includes a wireless communication chip and an antenna similar to those of communication unit 312 of mobile robot 310. Communication unit 322 can transmit the time limit information and the product information to mobile robot 310.

Imaging unit 323 captures a product. Imaging unit 323 includes an image sensor constituted of an imaging element, such as a charge coupled device (CCD), and a driving unit that moves the image sensor. Imaging unit 323 generates image data indicating an image captured by the image sensor, and supplies the image data to control unit 321.

In the present example embodiment, imaging unit 323 captures code information printed or stuck on a product or packaging thereof. The code information is, for example, a two-dimensional code, such as a QR code (registered trademark), or a bar code. The code information in the present example embodiment includes at least product identification data (ID) and an expiration date. The product ID are information for identifying a product (product name). The product ID correspond to one example of the product information. The expiration date corresponds to one example of the time limit information.

Note that imaging unit 323 may capture a character recognizable by optical character recognition (OCR) instead of the code information. In this case, product ID and an expiration date may be printed as they are (that is, by characters) on a product.

Imaging unit 323 can capture code information of each of a plurality of products. Specifically, imaging unit 323 is configured to be able to capture code information of each of a plurality of products arranged in different positions, by the driving unit causing the image sensor to move. However, a specific method of moving the image sensor is not particularly limited.

Product transfer unit 324 transfers a product. In other words, product transfer unit 324 moves a product from a certain place to a different place. Product transfer unit 324 moves a product displayed on shelf robot 320 to mobile robot 310. In addition, product transfer unit 324 in the present example embodiment can also perform so-called work of placing a product frontward, i.e., work of moving a product on the back side to an empty space on the front side of a shelf (putting a product on the back side close to the front). In this case, product transfer unit 324 may detect an empty space by a Photointerrupter, and perform the work of placing a product frontward when the empty space is generated.

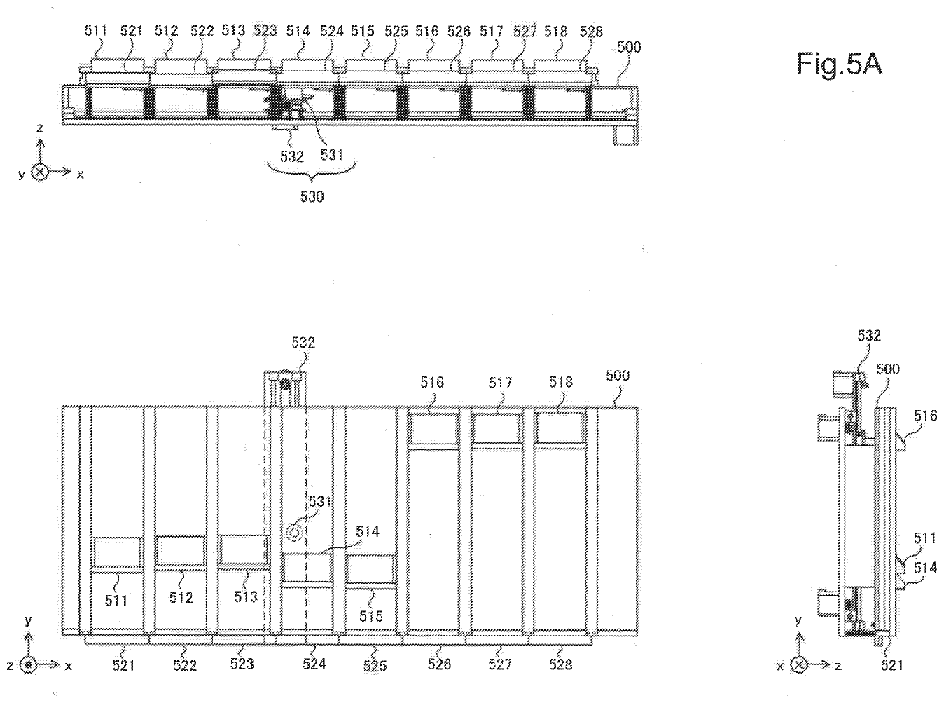

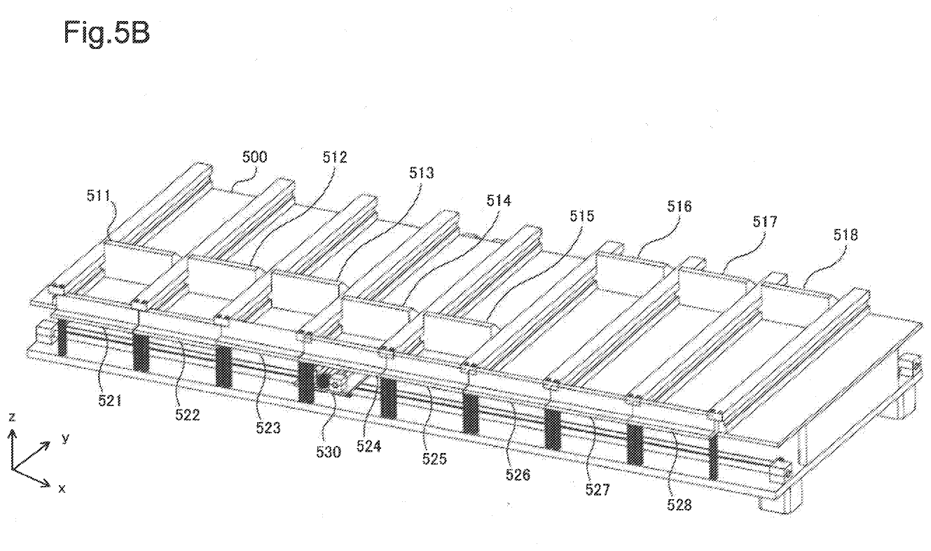

FIG. 5A is a diagram (front view, side view, and top view) illustrating a configuration example of shelf robot 320. Further, FIG. 5B is a perspective view illustrating the configuration example of shelf robot 320. Note that coordinate axes (x, y, z) of an orthogonal coordinate system illustrated in FIGS. 5A and 5B do not coincide with the coordinate axes (x, y, z) of the orthogonal coordinate system illustrated in FIG. 4, for the convenience of description. Specifically, while the orthogonal coordinate system in FIGS. 5A and 5B is a right-hand system, the orthogonal coordinate system in FIG. 4 is a left-hand system. Further, shelf robot 320 may include the configuration exemplified in FIGS. 5A and 5B in a plurality of steps in the z-axis direction.

Shelf robot 320 includes product shelf 500, partition plates 511, 512, 513, 514, 515, 516, 517, and 518, stoppers 521, 522, 523, 524, 525, 526, 527, and 528, and mobile camera 530. Note that the configuration example illustrated in FIGS. 5A and 5B is a configuration example when products are displayed in eight columns. The number of partition plates 511 to 518 and stoppers 521 to 528 is not limited to that in this configuration example. Further, it is assumed in this example that each product has the code information on a bottom surface (surface contacting product shelf 500).

Product shelf 500 is a plate-shaped member on which a product is placed. In the present example embodiment, product shelf 500 is configured to include a transparent member, in such a way as not to prevent capturing of the code information by mobile camera 531. However, the entire product shelf 500 may not need to be transparent. Further, product shelf 500 may be horizontal, and may also be inclined in such a way that the front side, i.e., a side with stoppers 521 to 528, becomes higher (or lower).

Partition plates 511 to 518 and stoppers 521 to 528 correspond to one example of product transfer unit 324. Partition plates 511 to 518 support a product in such a way that the product does not topple. Further, partition plates 511 to 518 can push a product forward by sliding in the negative y-axis direction in the diagram.

Stoppers 521 to 528 are members for preventing a product from falling from product shelf 500. However, stoppers 521 to 528 do not prevent a product from being transferred from shelf robot 320 to mobile robot 310, or from mobile robot 310 to shelf robot 320. For example, when a product is transferred from shelf robot 320 to mobile robot 310 and is pushed with force greater than or equal to fixed force by partition plates 511 to 518, stoppers 521 to 528 change a position or change a shape in such a way as to allow discharge of the product. Similarly, when a product is transferred from mobile robot 310 to shelf robot 320, stoppers 521 to 528 change a position or change a shape in such a way as to allow entry of the product being discharged from shelf robot 320. For example, stoppers 521 to 528 are configured to be able to descend and ascend in the z-axis direction by an elastic member such as a spring.

More specifically, mobile camera 530 includes image sensor 531 and driving mechanism 532. Image sensor 531 captures a bottom surface of a product placed on product shelf 500. Driving mechanism 532 moves image sensor 531 in the x-axis direction and the y-axis direction in the diagram. Image sensor 531 can successively capture pieces of code information of products aligned in one column, by being moved in the y-axis direction by driving mechanism 532.

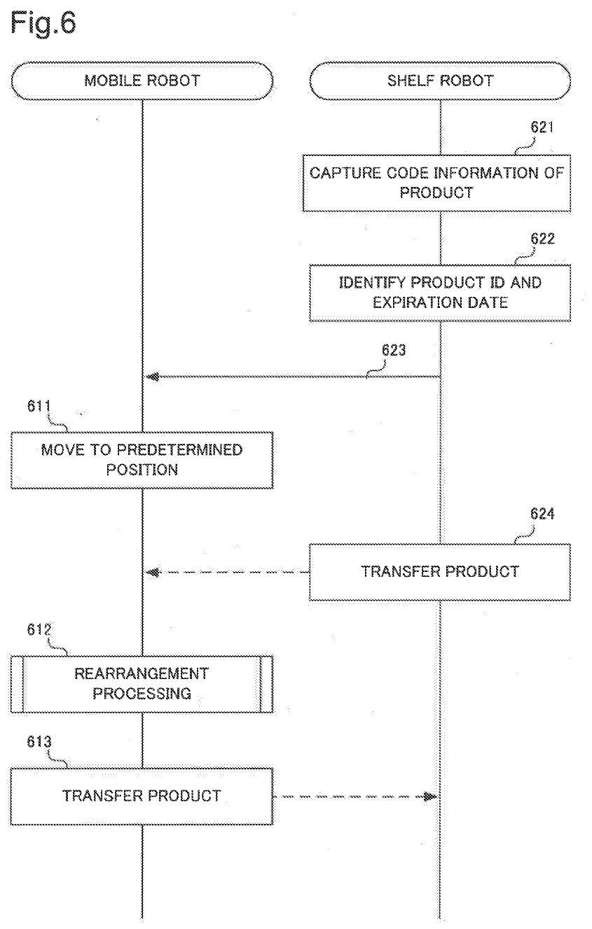

FIG. 6 is a sequence chart illustrating an operation of mobile robot 310 and shelf robot 320. Note that an arrow of a broken line indicates movement of a product in FIG. 6. Further, a part of processing illustrated in FIG. 6 is described later in detail, and a performing order thereof is not limited to an illustrated order.

In Step 621, shelf robot 320 captures code information of a product. For example, shelf robot 320 captures code information of a product in a specific column of product shelf 500. Alternatively, shelf robot 320 may capture pieces of code information of all products on product shelf 500. Note that it is assumed hereinafter that kinds of products vary from column to column, and products of the same kind (i.e., products having common product ID) are arranged in the same column.

In Step 622, shelf robot 320 identifies product ID and an expiration date of an individual product, based on the code information captured in Step 621. In Step 623, shelf robot 320 transmits the product ID and the expiration date of each product identified in Step 622 to mobile robot 310.

At this time, shelf robot 320 transmits the product ID and the expiration date to mobile robot 310 in such a way that mobile robot 310 can specify an order in which each product is arranged. For example, shelf robot 320 transmits the product ID and the expiration date, in an order (or a reverse order) from a product on the front side to a product on the back side of product shelf 500.

In Step 611, mobile robot 310 moves to a predetermined position in a store. Specifically, mobile robot 310 moves to the front of a product to be rearranged, and approaches shelf robot 320 to a position in which the product can be transferred. Note that a supplementary product may be placed on mobile robot 310 before the movement in Step 611.

Mobile robot 310 may move to the front of a product to be rearranged, based on the product ID transmitted from shelf robot 320 in Step 623. In this case, a position of a product in a store is previously associated with the product ID. Mobile robot 310 may move in a store by, for example, referring to map data in which a correspondence between a position of a product in a store and product ID is described.

Alternatively, mobile robot 310 may move by manipulation of an operator. In this case, product information is not needed for the movement of mobile robot 310. When product information is not needed for the movement, mobile robot 310 may move in advance before performing the processing in Steps 621 and 622.

In Step 624, shelf robot 320 transfers the product to be rearranged to mobile robot 310. For example, shelf robot 320 discharges the product by moving the product by causing any of partition plates 511 to 518 to slide. At this time, mobile robot 310 receives the product discharged from shelf robot 320 into casing 421, by adjusting a height of casing 421 by lift 424 as necessary, and then driving conveyor 423. The transferred product is placed in a predetermined position of casing 421.

Mobile robot 310 houses the product to be rearranged, and then performs processing in Step 612. This processing is processing of changing arrangement of a product housed in mobile robot 310. Mobile robot 310 changes arrangement of a product, based on rule information according to the product ID transmitted in Step 623. In the rule information, for example, an order (ascending order, descending order, or the like) in which products are arranged based on an expiration date and a condition for classifying products based on an expiration date are described. Hereinafter, the processing in Step 612 is also referred to as “rearrangement processing”.

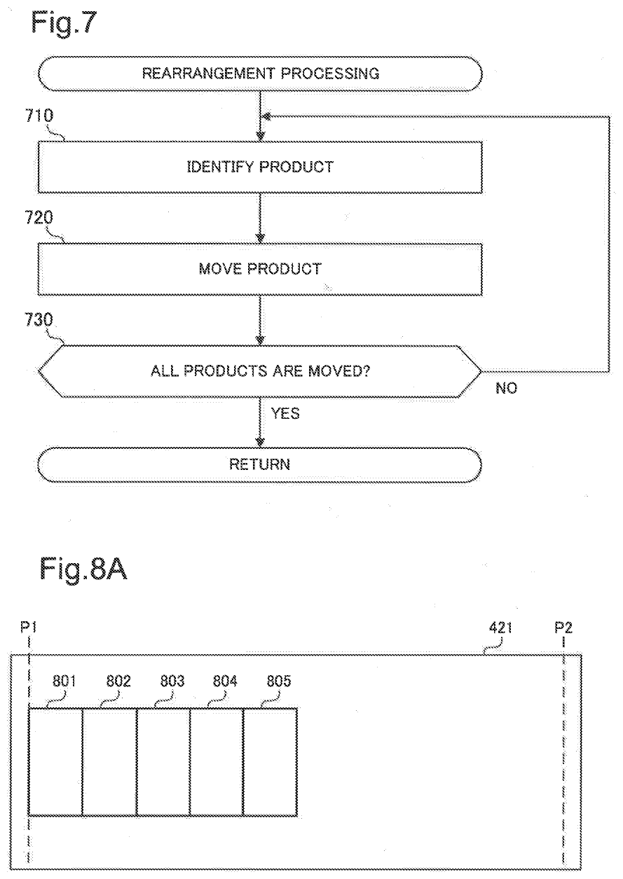

FIG. 7 is a flowchart illustrating one example of the rearrangement processing. In Step 710, mobile robot 310 specifies a product before movement having the latest expiration date, with reference to a time of performing the processing, among products housed in casing 421. The product before the movement herein is a product on which processing in Step 720 is not performed.

In Step 720, mobile robot 310 moves the product specified in Step 710 to a predetermined position. Specifically, mobile robot 310 moves the product specified in Step 710 in such a way that the product is arranged to be the deepest (i.e., on the farthest side) from a customer. Mobile robot 310 can refer to size information associated with the product ID, by using the product ID transmitted in Step 623. Mobile robot 310 identifies a position of an individual product housed in casing 421, by using this size information (details are described later).

In Step 730, mobile robot 310 determines whether all the products housed in casing 421 are moved. In other words, mobile robot 310 determines whether there is a product on which the processing in Step 720 is not performed. When there is a product before the movement (NO in Step 720), mobile robot 310 performs the processing in Step 710 again.

Mobile robot 310 can successively move a plurality of products housed in casing 421, by repeating such processing. Then, when all products housed in casing 421 are moved (YES in Step 720), mobile robot 310 finishes the rearrangement processing.

Note that mobile robot 310 may determine whether there is a product having an expiration date before a time of performing the processing, i.e., a product past an expiration date. When there is a product past an expiration date, mobile robot 310 moves the product to box 425. In other words, mobile robot 310 classifies products into a product past an expiration date and a product that is not past an expiration date, and moves each product to different place.

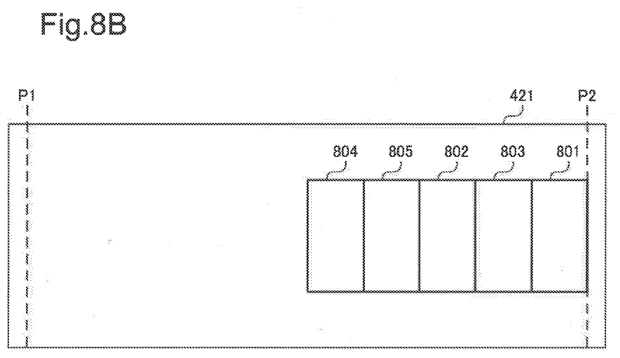

FIGS. 8A and 8B are diagrams illustrating a specific example of the rearrangement processing in the present example embodiment. FIG. 8A illustrates, in casing 421, arrangement of products before the rearrangement processing. On the other hand, FIG. 8B illustrates, in casing 421, arrangement of the products after the rearrangement processing. Herein, reference positions P1 and P2 are predetermined positions as references to the arrangement of the products.

In this example, mobile robot 310 changes arrangement of products 801, 802, 803, 804, and 805. Further, it is assumed that expiration dates of products 801 to 805 are as follows (all the expiration dates are the same day). Mobile robot 310 receives the expiration dates of the products 801 to 805 in the following order from shelf robot 320.

First: product 801 (expiration date: 20:00)
Second: product 802 (expiration date: 16:00)
Third: product 803 (expiration date: 18:00)
Fourth: product 804 (expiration date: 12:00)
Fifth: product 805 (expiration date: 14:00)

In this example, mobile robot 310 first moves product 801 having the latest expiration date. At this time, mobile robot 310 determines that product 801 is the first from reference position P1, and holds and moves product 801 to reference position P2.

Next, mobile robot 310 moves product 803 having a late expiration date following product 801. At this time, mobile robot 310 determines that product 803 is the third from reference position P1, and holds and moves product 803 to be adjacent to product 801. Further, mobile robot 310 determines a position in which product 803 is arranged, based on size information. Specifically, mobile robot 310 arranges product 803 toward the front by one product with respect to a position in which product 801 is arranged.

Mobile robot 310 successively changes positions of products 801 to 805 by repeating such an operation. As a result, products 801 to 805 are rearranged as illustrated in FIG. 8B. In FIG. 8B, products 801 to 805 having earlier expiration dates are arranged toward the left.

Note that the rearrangement processing described above is merely one example. Specific order and method of rearranging products by mobile robot 310 are not limited to this example. For example, mobile robot 310 may first move a product having the earliest expiration date. Further, mobile robot 310 may arrange a product having a later expiration date toward the left.

When the rearrangement processing is finished, mobile robot 310 perform processing in Step 613. In Step 613, mobile robot 310 transfers the rearranged product to shelf robot 320. In other words, mobile robot 310 changes arrangement of the product, and returns the product having arrangement being changed to shelf robot 320. Transfer of the product from mobile robot 310 to shelf robot 320 in Step 613 is a reverse operation of transfer of the product from shelf robot 320 to mobile robot 310 in Step 624.

As described above, work assistance system 300 in the present example embodiment has a configuration in such a way as to identify expiration dates from a plurality of products, and change arrangement of the plurality of products, based on the expiration dates. This configuration allows, for example, arrangement to be changed in such a way that a plurality of products line up in an order of expiration dates.

For example, when shelf stocking work is performed in a store, an employee may replenish from the front side of a product shelf, seen from a customer, with a new product to be displayed on the product shelf, i.e., a product having a later expiration date than that of a product already displayed on the product shelf. In such a case, when the new product is put at the front of the product shelf, the new product is more likely to be purchased before the product already displayed. On the other hand, when the new product is intended to be put on the back side of the product shelf, an employee needs more time and effort.

Further, even when an employee arranges products on the product shelf in a predetermined order, the arrangement is not necessarily maintained. For example, when a customer picks up a product and returns the product to a place different from an original place, arrangement of products may be changed. Particularly, a customer, who knows that a product having a late expiration date is located on the back side of the product shelf from experience, may return a product taken out from the back side of the product shelf to the front side of the product shelf. Therefore, an employee is required to perform work of checking the product shelf at appropriate timing and rearranging products in an appropriate order, in order to suppress occurrence of a product past an expiration date.

Work assistance system 300 can reduce a burden of work on an employee that is needed for the shelf stocking work and the work of rearranging products by performing the rearrangement processing described above. Therefore, work assistance system 300 can efficiently assist work of an employee in a store.

### Third Example Embodiment

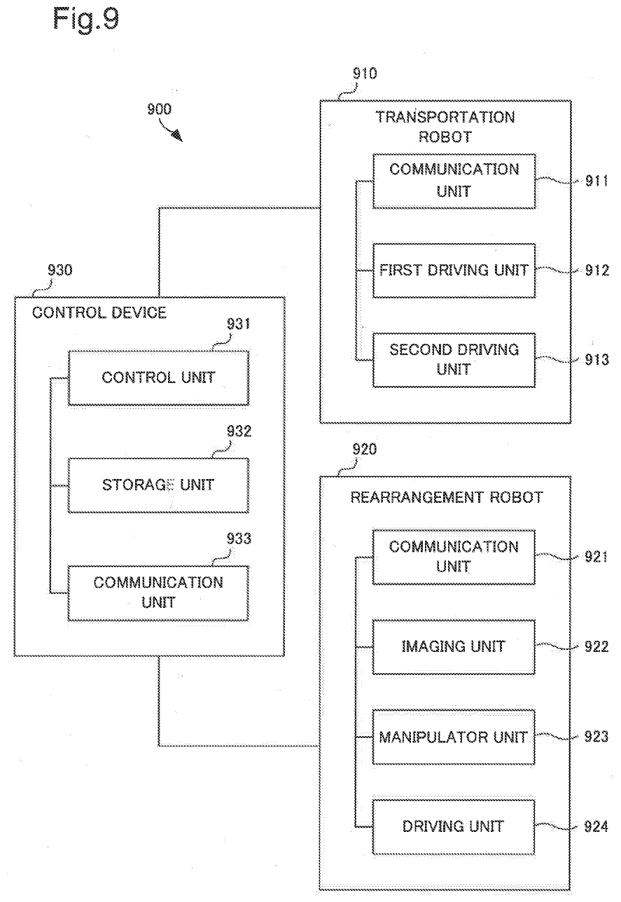

FIG. 9 is a block diagram illustrating a configuration of work assistance system 900 according to still another example embodiment. Work assistance system 900 includes transportation robot 910, rearrangement robot 920, and control device 930. Work assistance system 900 corresponds to one example of work assistance system 100 in the first example embodiment. Note that description of matters common to the first and second example embodiments will be appropriately omitted in the present example embodiment.

Transportation robot 910 is a device that transports a shelf and a food tray (tray on which a product is placed) to a work area in a store. Rearrangement robot 920 is a device that is installed in a work area and rearranges products placed on a shelf and a food tray. Control device 930 is a computer device communicably connected to transportation robot 910 and rearrangement robot 920. Note that control device 930 may be connected to transportation robot 910 and rearrangement robot 920 via a network such as the Internet. Therefore, server device 930 does not necessarily need to be located in a store.

Transportation robot 910 includes communication unit 911, first driving unit 912, and second driving unit 913. Communication unit 911 exchanges data with control device 930. First driving unit 912 moves transportation robot 910. Second driving unit 913 moves a loaded object. The loaded object herein is a shelf or a food tray.

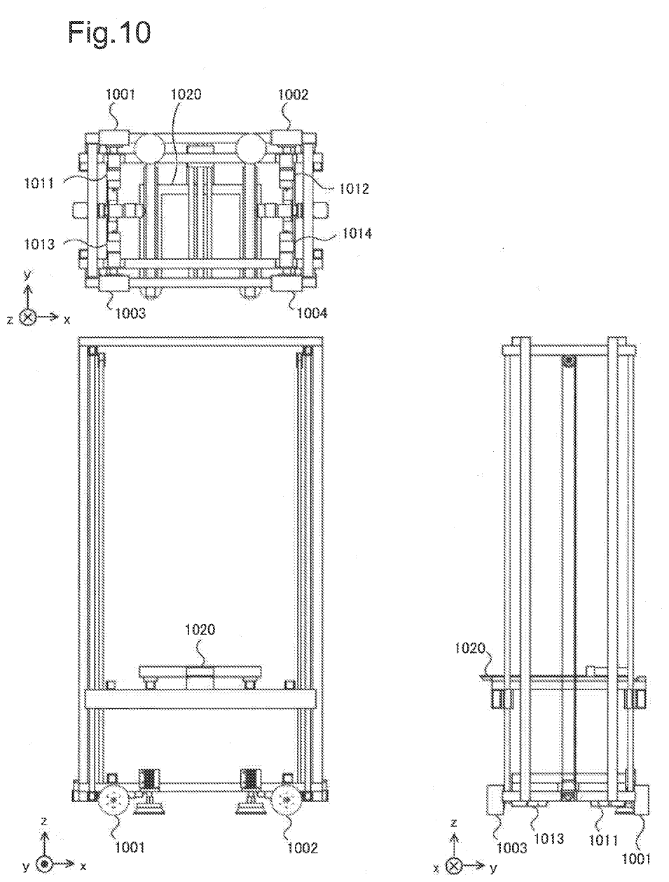

FIG. 10 is a diagram (front view, side view, and bottom view) illustrating a configuration example of transportation robot 910. Transportation robot 910 includes Mecanum wheels 1001, 1002, 1003, and 1004, motors 1011, 1012, 1013, and 1014, and movable base 1020.

Mecanum wheels 1001 to 1004 and motors 1011 to 1014 correspond to one example of first driving unit 912. Mecanum wheels 1001 to 1004 and motors 1011 to 1014 move transportation robot 910, by being driven according to control by control device 930. Movable base 1020 corresponds to one example of second driving unit 913. Movable base 1020 is a base on which a shelf or a food tray is placed, and is movable in the y and z-axis directions in the diagram. Movable base 1020 can deliver a shelf or a food tray to rearrangement robot 920, by a combination of movement in the y-axis direction and movement in the z-axis direction (i.e., up-and-down movement).

Rearrangement robot 920 includes communication unit 921, imaging unit 922, manipulator unit 923, and driving unit 924. Communication unit 921 exchanges data with control device 930. Imaging unit 922 captures a product. More specifically, imaging unit 922 captures code information provided to a product and generates image data. The code information in the present example embodiment is similar to the code information in the second example embodiment. Manipulator unit 923 moves a product. Driving unit 924 moves imaging unit 922 and manipulator unit 923.

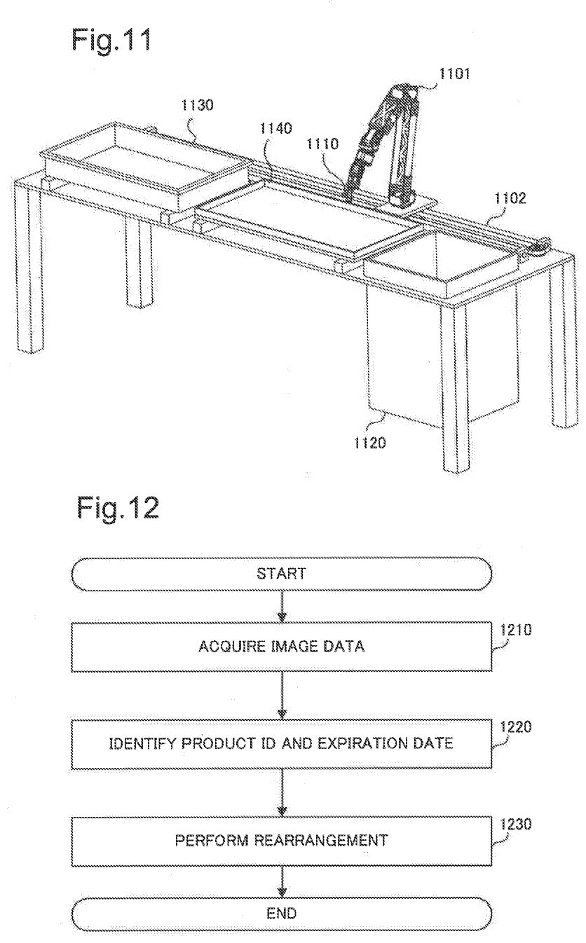

FIG. 11 is a perspective view illustrating a configuration example of rearrangement robot 920. Rearrangement robot 920 includes manipulator 1101, rail 1102, camera 1110, and box 1120. Note that it is assumed that the code information of a product is provided to an upper surface of the product in this configuration example.

Manipulator 1101 and rail 1102 correspond to one example of manipulator unit 923 and driving unit 924, respectively. Manipulator 1101 moves a product placed on food tray 1130 or shelf 1140. Manipulator 1101 is configured to be movable in the y-axis direction in the diagram along rail 1102.

Camera 1110 corresponds to one example of imaging unit 922. In this configuration example, camera 1110 is mounted on an end-effector of manipulator 1101. In other words, it can be said that manipulator 1101 is a manipulator with a camera. However, camera 1110 may be configured to be movable independently of manipulator 1101.

Box 1120 houses some of products placed on food tray 1130 or shelf 1140. Some of the products placed on food tray 1130 or shelf 1140 are thrown into box 1120 by manipulator 1101 and rail 1102. The product thrown into box 1120 is, for example, a product past an expiration date.

Control device 930 includes control unit 931, storage unit 932, and communication unit 933. Control unit 931 includes an arithmetic processing device such as a CPU and a memory, and controls operations of transportation robot 910 and rearrangement robot 920 by executing a program. Storage unit 932 includes a storage device such as a hard disk. Storage unit 932 stores rule information associated with product information. The rule information may vary with product ID. Communication unit 933 exchanges data with transportation robot 910 and rearrangement robot 920.

Note that storage unit 932 may store size information in addition to the rule information, which is not essential. For example, when rearrangement robot 920 can recognize size and shape of a product, based on an image captured by imaging unit 922, the size information may not be stored in storage unit 932.

Work assistance system 900 has the configuration described above. In such a configuration, transportation robot 910 transports a shelf or a food tray of a product on which the shelf stocking work or the rearrangement work is performed, to a work area. When the shelf stocking work is performed, transportation robot 910 transports a shelf and a food tray to a work area. On the other hand, when the rearrangement work is performed, transportation robot 910 may transport only a shelf to a work area. A shelf and a food tray are set in predetermined positions of rearrangement robot 920 by transportation robot 910 (or an employee in a work area).

At this time, control device 930 controls operations of transportation robot 910 and rearrangement robot 920. Control device 930 may control operations of transportation robot 910 and rearrangement robot 920 automatically (i.e., without an operation of an operator) according to a predetermined program, and may perform a part of operations according to an operation of an operator.

FIG. 12 is a flowchart illustrating processing performed by control device 930 after a shelf and a food tray are set. In Step 1210, control unit 931 acquires image data acquired by capturing a product, from rearrangement robot 920. Control unit 931 acquires the image data via communication unit 933. Rearrangement robot 920 captures a plurality of products placed on the shelf and the food tray by capturing for one or a plurality of times.

In Step 1220, control unit 931 identifies product ID and expiration dates of the plurality of products. At this time, control unit 931 compares product ID identified from respective products, and, when there is a product having a piece of product ID different from that of another product (i.e., a product of a different kind), control unit 931 may move the product to a place (food tray or box 1120) other than the shelf.

In Step 1230, control unit 931 causes rearrangement robot 920 to perform rearrangement of the products. Specifically, control unit 931 refers to rule information associated with the product ID identified in Step 1220, and changes arrangement of the products according to a rule indicated by the rule information. At this time, control unit 931 may move a product placed on the food tray to the shelf, or move a product placed on the shelf to box 1120.

As described above, work assistance system 900 in the present example embodiment has a configuration in such a way as to identify expiration dates from a plurality of products, and change arrangement of the plurality of products, based on the expiration dates. This configuration can achieve an effect similar to that of work assistance system 300 in the second example embodiment. Therefore, work assistance system 900 can efficiently assist work of an employee in a store.

Further, work assistance system 900 in the present example embodiment has advantages in such a way that a plurality of imaging units 922 may not need to be provided even with a plurality of shelves, and a product placed on not only a shelf but also on a food tray can also be captured, in comparison with work assistance system 300 in the second example embodiment. On the other hand, work assistance system 300 in the second example embodiment has advantages in such a way that a shelf itself does not need to be moved, an expiration date can be checked without moving a shelf, and the work of placing a product frontward can be performed, in comparison with work assistance system 900 in the present example embodiment.

### MODIFICATION EXAMPLE

For example, the following modification examples are applicable to the first to third example embodiments described above. These modification examples can be appropriately combined as necessary.

### Modification Example 1

Work assistance system 300 in the second example embodiment may further include a control device. This control device may include a part or the whole of a function of control device 930 in the third example embodiment. For example, the control device may be configured to store rule information associated with product ID and transmit the rule information to mobile robot 310 as necessary.

### Modification Example 2

Work assistance system 900 in the third example embodiment may not include control device 930. In this case, transportation robot 910 or rearrangement robot 920 includes the function of control device 930. For example, the rule information is stored in rearrangement robot 920. Note that transportation robot 910 and rearrangement robot 920 do not need to be able to communicate with each other.

### Modification Example 3

Control device 930 in the third example embodiment may change rule information. For example, control unit 931 of control device 930 may change rule information according to time (such as morning and night) and day (such as weekday and weekend). Alternatively, control unit 931 may update rule information in such a way that sales are optimized by using artificial intelligence (AI), for example, machine learning.

### Modification Example 4

Change unit 120 in the first example embodiment may classify products into a product having a time indicated by time information that satisfies a predetermined condition and another product, and arrange the products. A condition that enables such classification is described in the rule information.

For example, control device 930 in the third example embodiment may cause rearrangement robot 920 to arrange products in such a way that a product having a close expiration date (for example, a product to be past an expiration date within n hours from a current time) and a product that does not have a close expiration date are classified. Specifically, control unit 931 of control device 930 may cause rearrangement robot 920 to arrange products in such a way that a product having a close expiration date is put toward the right of a shelf and the other product is put toward the left of the shelf. Note that a value of n herein is not limited to a specific value as long as it is a positive value, and may vary with a kind of a product. Further, control device 930 can also classify products into a product past an expiration date and a product that is not past an expiration date. Control device 930 operates in such a manner, and can thus reduce a burden of the work of classifying products into a product having a close expiration date and a product past an expiration date by an employee.

### Modification Example 5

Rearrangement robot 920 in the third example embodiment (or mobile robot 310 in the second example embodiment) may further include a function of sticking a sticky label to a product. This function may be provided in, for example, manipulator 1101 of rearrangement robot 920. The sticky label herein includes a sticky label on which a discount rate of a product is described, in addition to a so-called price tag.

In a retail store, a product having a close expiration date may be on sale as a cut-price product (a bargain) at a lower cost than that of a product that does not have a close expiration date. When such a discount sale is conducted, an employee normally needs to perform work of finding a product having a close expiration date from a product shelf, and sticking a sticky label on which a discount rate or a price after discount is described on the product.

When rearrangement robot 920 includes the function of sticking a sticky label, control device 930 may control rearrangement robot 920 in such a way that rearrangement robot 920 sticks a sticky label on a product having an expiration date that satisfies a predetermined condition. For example, when control device 930 classifies products into a product having a close expiration date and the other product and arranges the products as described in Modification Example 4, control device 930 controls rearrangement robot 920 in such a way that rearrangement robot 920 sticks a sticky label indicating that a product is a cut-price product on only a product having a close expiration date. In this way, a burden of the work of an employee can be reduced.

### Modification Example 6

Mobile robot 310 in the second example embodiment (or transportation robot 910 in the third example embodiment) may change an arrangement place of a product. For example, mobile robot 310 may arrange a product that has been arranged at a certain place at a different place.

When work assistance system 300 in the second example embodiment includes the control device described in Modification Example 2, the control device may further include a function of recommending an arrangement place of a product. For example, the control device may predict arrangement of products that maximizes sales in a certain store, by using a method such as an optimization problem, based on sales in a past certain period in the store and arrangement of products in the store during the period.

### Modification Example 7

The work assistance system (100, 300, or 900) according to the present disclosure can also be used for an article other than a product. For example, the work assistance system according to the present disclosure can also be used for changing arrangement of parts or materials of merchandise at a factory.

### Modification Example 8

A specific hardware configuration of the device according to the present disclosure has diverse variations, and is not limited to a specific configuration. For example, the device according to the present disclosure may be achieved by using software, or configured to share various processing by using a plurality of hardware.

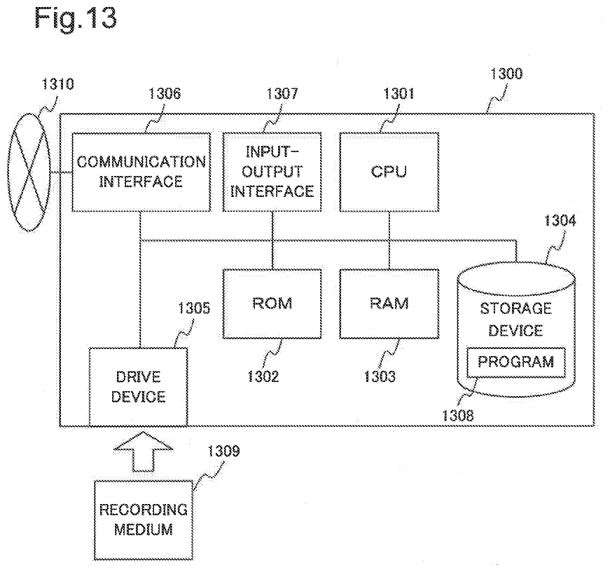

FIG. 13 is a block diagram illustrating one example of a hardware configuration of computer device 1300 that achieves the device according to the present disclosure. Computer device 1300 is configured to include central processing unit (CPU) 1301, read only memory (ROM) 1302, random access memory (RAM) 1303, storage device 1304, drive device 1305, communication interface 1306, and input-output interface 1307. The device according to the present disclosure may be achieved by the configuration (or a part thereof) illustrated in FIG. 13.

CPU 1301 executes program 1308 by using RAM 1303. Program 1308 may be stored in ROM 1302. Further, program 1308 may be recorded in recording medium 1309 such as a memory card, and read by drive device 1305, or may be transmitted from an external device via network 1310. Communication interface 1306 exchanges data with an external device via network 1310. Input-output interface 1307 exchanges data with a peripheral device (such as an input device and a display device). Communication interface 1306 and input-output interface 1307 may function as a component for acquiring or outputting data.

Note that a component of the device according to the present disclosure may be constituted of a single circuit (such as a processor) or a combination of a plurality of circuits. The circuit (circuitry) herein may be either a dedicated or a general-purpose circuit. For example, a part of the device according to the present disclosure may be achieved by a dedicated processor, and the other part thereof may be achieved by a general-purpose processor.

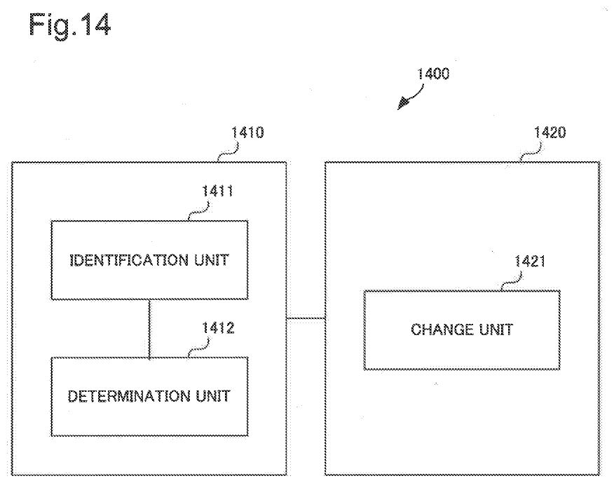

FIG. 14 is a block diagram illustrating a configuration of work assistance system 1400 according to the present disclosure. Work assistance system 1400 includes first device 1410 and second device 1420. Work assistance system 1400 is one of configuration examples that achieve work assistance system 100 in the first example embodiment by cooperation of a plurality of devices.

First device 1410 includes identification unit 1411 and determination unit 1412. Identification unit 1411 identifies information associated with a product based on the product. A specific operation of identification unit 1411 may be similar to that of identification unit 110 in the first example embodiment. Determination unit 1412 determines arrangement of products, based on information identified by identification unit 1411. Determination unit 1412 may determine arrangement of products in such a way that times indicated by pieces of time information identified by identification unit 1411 are in an ascending order or a descending order, for example. Further, determination unit 1412 may determine whether arrangement of the products having the information identified by identification unit 1411 needs to be changed, similarly to change unit 120 in the first example embodiment.

Second device 1420 includes change unit 1421. Change unit 1421 changes arrangement of products according to determination by determination unit 1412. When determination unit 1412 determines that the arrangement of the products does not need to be changed, change unit 1421 may not change the arrangement of the products. In this example, it can also be said that change unit 1421 achieves a function corresponding to change unit 120 in the first example embodiment, by cooperating with determination unit 1412.

First device 1410 corresponds to one example of the work assistance device according to the present disclosure. It can also be said that the work assistance device according to the present disclosure has a configuration in which change unit 120 in operation assistance system 100 in FIG. 1 is replaced with determination unit 1412.

The configuration described as a single device in the above-described example embodiments may be distributed in a plurality of devices. For example, control device 930 may be achieved by cooperation of a plurality of computer devices, by using a cloud computing technology.

As described above, the present invention is described by taking the example embodiments and the modification examples described above as model examples. However, the present invention is not limited to these example embodiments and modification examples. The present invention may include an example embodiment to which various modifications or applications that may be understood by a so-called person skilled in the art are applied, within the scope of the present invention. Further, the present invention may include an example embodiment in which matters described in the description are appropriately combined or replaced as necessary. For example, a matter described with a specific example embodiment may also be applied to another example embodiment, within a consistent range.

### REFERENCE SIGNS LIST

100, 300, 900, 1400 Work assistance system
110 Identification unit
120 Change unit
310 Mobile robot
320 Shelf robot
910 Transportation robot
920 Rearrangement robot
930 Control device
1300 Computer device

What is claimed is:

1. A work assistance system, comprising:
an identification unit configured to identify, based on each of a plurality of products to be arranged at a certain place, time information indicating a time associated with the product; and
a change unit configured to change arrangement of the plurality of products, based on rule information including at least a condition for arrangement according to a time indicated by the identified time information.

2. The work assistance system according to claim 1, wherein
the change unit changes arrangement of the plurality of products in such a way that times indicated by the time information are in an ascending order or in a descending order.

3. The work assistance system according to claim 1, wherein
the change unit classifies products into a product having a time indicated by the time information, which satisfies a predetermined condition, and another product, and arranges the products.

4. The work assistance system according to claim 1, wherein
the identification unit identifies the time information and product information that identifies the plurality of products, and
the change unit changes arrangement of the plurality of products, based on the rule information according to the identified product information.

5. The work assistance system according to claim 1, further comprising
a first device and a second device, wherein
the first device includes
a transfer unit configured to transfer the plurality of products to the second device,
the second device includes
the identification unit,
the change unit, and
a placement unit configured to place the plurality of transferred products, and
the change unit changes arrangement of the plurality of placed products.

6. The work assistance system according to claim 1, further comprising
a first device and a second device, wherein
the first device includes
a shelf on which the plurality of products are arranged,
the identification unit, and
a first transfer unit configured to transfer the plurality of products arranged on the shelf to the second device,
the second device includes
a placement unit configured to place the plurality of transferred products,
the change unit, and
a second transfer unit configured to transfer at least some of the plurality of products having arrangement being changed by the change unit to the first device,
the identification unit identifies the time information from each of the plurality of products arranged on the shelf, and
the change unit changes arrangement of the plurality of products placed by the placement unit.

7. A work assistance method, comprising:
identifying, based on each of a plurality of products arranged at a certain place, time information indicating a time associated with the product; and
changing arrangement of the plurality of products, based on rule information including at least a condition for arrangement according to a time indicated by the identified time information.

8. The work assistance method according to claim 7, wherein
the changing includes changing arrangement of the plurality of products in such a way that times indicated by the time information are in an ascending order or in a descending order.

9. A non-transitory computer readable recording medium that records a program for causing a computer to execute:
processing of identifying, based on each of a plurality of products arranged at a certain place, time information indicating a time associated with the product; and
processing of changing arrangement of the plurality of products, based on rule information including at least a condition for arrangement according to a time indicated by the identified time information.

10. The recording medium according to claim 9, wherein
the processing of changing includes processing of changing arrangement of the plurality of products in such a way that times indicated by the time information are in an ascending order or in a descending order.

11. The work assistance system according to claim 2, wherein
the change unit classifies products into a product having a time indicated by the time information, which satisfies a predetermined condition, and another product, and arranges the products.

12. The work assistance system according to claim 2, wherein
the identification unit identifies the time information and product information that identifies the plurality of products, and
the change unit changes arrangement of the plurality of products, based on the rule information according to the identified product information.

13. The work assistance system according to claim 3, wherein
the identification unit identifies the time information and product information that identifies the plurality of products, and
the change unit changes arrangement of the plurality of products, based on the rule information according to the identified product information.

14. The work assistance system according to claim 2, further comprising
a first device and a second device, wherein
the first device includes
a transfer unit configured to transfer the plurality of products to the second device,
the second device includes
the identification unit,
the change unit, and
a placement unit configured to place the plurality of transferred products, and
the change unit changes arrangement of the plurality of placed products.

15. The work assistance system according to claim 3, further comprising
a first device and a second device, wherein
the first device includes
a transfer unit configured to transfer the plurality of products to the second device,
the second device includes
the identification unit,
the change unit, and
a placement unit configured to place the plurality of transferred products, and
the change unit changes arrangement of the plurality of placed products.

16. The work assistance system according to claim 4, further comprising
a first device and a second device, wherein
the first device includes
a transfer unit configured to transfer the plurality of products to the second device,
the second device includes
the identification unit,
the change unit, and
a placement unit configured to place the plurality of transferred products, and
the change unit changes arrangement of the plurality of placed products.

17. The work assistance system according to claim 2, further comprising
a first device and a second device, wherein
the first device includes
a shelf on which the plurality of products are arranged,
the identification unit, and
a first transfer unit configured to transfer the plurality of products arranged on the shelf to the second device,
the second device includes
a placement unit configured to place the plurality of transferred products,
the change unit, and
a second transfer unit configured to transfer at least some of the plurality of products having arrangement being changed by the change unit to the first device,
the identification unit identifies the time information from each of the plurality of products arranged on the shelf, and
the change unit changes arrangement of the plurality of products placed by the placement unit.

18. The work assistance system according to claim 3, further comprising
a first device and a second device, wherein
the first device includes
a shelf on which the plurality of products are arranged,
the identification unit, and
a first transfer unit configured to transfer the plurality of products arranged on the shelf to the second device,
the second device includes
a placement unit configured to place the plurality of transferred products,
the change unit, and
a second transfer unit configured to transfer at least some of the plurality of products having arrangement being changed by the change unit to the first device,
the identification unit identifies the time information from each of the plurality of products arranged on the shelf, and
the change unit changes arrangement of the plurality of products placed by the placement unit.

19. The work assistance system according to claim 4, further comprising
a first device and a second device, wherein
the first device includes
a shelf on which the plurality of products are arranged,
the identification unit, and
a first transfer unit configured to transfer the plurality of products arranged on the shelf to the second device,
the second device includes
a placement unit configured to place the plurality of transferred products,
the change unit, and
a second transfer unit configured to transfer at least some of the plurality of products having arrangement being changed by the change unit to the first device,
the identification unit identifies the time information from each of the plurality of products arranged on the shelf, and
the change unit changes arrangement of the plurality of products placed by the placement unit.
